(19) United States
(12) Patent Application Publication
(10) Pub. No.: US 2016/0236376 A1
(43) Pub. Date: Aug. 18, 2016

(54) USE OF FABRIC CUTTING SCRAP

(71) Applicant: BASF SE, Ludwigshafen (DE)

(72) Inventors: Matthias SCHEIBITZ, Weinheim (DE); Heiko HESS, Lauterecken (DE); Jens CREMER, Gruenstadt (DE)

(73) Assignee: BASF SE, Ludwigshafen (DE)

(21) Appl. No.: 15/024,532

(22) PCT Filed: Sep. 12, 2014
(86) PCT No.: PCT/EP14/69516

§ 371 Date: Mar. 24, 2016

(30) Foreign Application Priority Data
Sep. 24, 2013 (EP) 13185706.2

(51) Int. Cl. B29B 9/14; B29B 9/04; C08J 3/20; B29B 7/38; C08J 5/04; B29B 9/06; B29B 15/10

(52) U.S. Cl. CPC B29B 9/14; B29B 9/06; B29B 9/065; B29B 9/04; B29B 15/105; B29B 7/38; C08J 5/042; C08J 3/203; B29K 2105/0067

(57) ABSTRACT

The invention provides a method of using fabric cutting scrap, which method comprises the steps of:
(e) cutting the cutting scrap into flakes,
(f) admixing the flakes to a polymer melt,
(g) kneading the polymer melt with the flakes, so the flakes disintegrate into individual fibers,
(h) molding the polymer melt with the admixed fibers into an intermediate article.

The present invention relates to a method of using fabric cutting scrap.

Fabric is, for example, fabric knitted, woven or laid from fiber as used in the manufacture of continuous strand composites.

Continuous strand composites are typically formed by inserting a fabric into a mold and then filling the mold with a cast polymer, for example with a thermosetting polymer or with a thermoplastic polymer. The fabric used can be for example a woven fabric, a knitted fabric or a laid fabric. It is possible to superpose two or more fabrics with or without rotation relative to each other.

Especially when the fabrics take the form of wovens, knits or of parallel fibers held together by auxiliary threads, they have a shape that does not coincide with the shape of the component to be produced. So the fabrics needed to produce the component first have to be cut to size. The cutting scrap generated in the process cannot be used to produce further continuous strand reinforced components. The cutting scrap is therefore typically sent for disposal. Especially carbon fiber cutting scrap is currently disposed of by incineration, but this is undesirable because of the high cost of carbon fiber.

In addition to thermal recovery, DE-A 10 2009 023 529 discloses a process whereby fiber composite scrap of unimpregnated carbon fiber is first cut into segments of defined fiber length; these are destructurized to the point of fiber individualization and the resultant carbon fiber in random form is reorganized into a fibrous nonwoven web or into a fibrous card web which is spun into a continuous yarn. What transpires here as particularly problematic is that a substantially non-destructive re-use through disassembly into individual fibers by the type of repetitive impact (in a hammer mill, for example) as practiced for aramid or Kevlar fibers cannot be used for carbon fibers. This is particularly because of the fragility of carbon fibers, which such a process cannot comminute into meterable or very short fibers, so adequate reinforcement of polymer parts with these fibers cannot be achieved. A particular disadvantage of the process described in DE-A 10 2009 023 529 is the immense expenditure needed to claim a meterable material. Direct use of the cut segments is not possible in the existing processes.

The problem addressed by the present invention was therefore that of providing a method of using fabric cutting scrap without the disadvantages of the prior art.

This problem is solved by a method of using fabric cutting scrap, which method comprises the steps of:
(a) cutting the cutting scrap into flakes,
(b) admixing the flakes to a polymer melt,
(c) kneading the polymer melt with the flakes, so the flakes disintegrate into individual fibers,
(d) molding the polymer melt with the admixed fibers into an intermediate article.

Cutting the scrap into flakes provides a simple way of mixing the individual flakes into a polymer melt. Owing to the fact that the scrap is comminuted into flakes, the original bond between the fibers is no longer sufficient for the flakes to retain their form, so they disintegrate into individual fibers in the course of being mixed into and kneaded in the polymer melt. This makes it possible to use the flakes to produce a fiber reinforced polymer corresponding to a chopped strand material.

In one preferred embodiment, the fabrics that generate the cutting scrap are wovens, laids, knits, braids, nonwovens or mats that are typically fabricated from continuous strand fiber. Useful wovens include any wovens obtainable from continuous strand fiber. It is also possible to use any desired knits. Laids for the purposes of the present invention are fabrics in which individual fibers are in a parallel arrangement. It is also possible here for the fabric to be constructed of two or more plies, while the individual plies can be aligned parallel to each other or else be twisted in any desired angle relative to each other.

When the fibers are in the form of a laid fabric, the individual parallel fibers are interconnected by means of fibers or polymer threads for example. The interconnection here takes the form, for example, of a seam stitched from the synthetic fibers or continuous strand fibers. The seam is preferably formed using a synthetic fiber, for example a polymer fiber. A seam here comprises, for example, an underthread vertical to the laid-fiber fabric and an overthread which is stitched through the fibers at predefined intervals and loops around the underthread.

The fabrics used may comprise fibers which have been pretreated with a sizing composition, or untreated fibers. It is further also possible for the fabrics to be already drenched with a polymer, in particular a thermoplastic polymer. It is preferable, however, for the fibers to be untreated or at most to be pretreated with a sizing composition.

Especially when the fibers of the cutting scrap are untreated, it is preferable for the flakes to be treated with a sizing composition after the cutting scrap has been cut into flakes and before the flakes are admixed to the polymer melt. Any sizing composition known to a person skilled in the art can be used. The treatment with a sizing composition has the advantage of improving the adherence of the polymer to the fiber and thus effecting an overall improvement in the properties of the fiber reinforced polymer obtained by the method of the present invention. Especially when individual fibers are used and/or when the flakes are cut from laid-fiber fabrics, pretreatment of the fibers is advantageous. It is particularly preferable for the fibers to be drenched with a binder in order to convert them into a meterable form. Flakes are an example of a meterable form. Fiber flakes are advantageous to individual fibers in that they are easier to mix via a conventional feed device into a machine for kneading the polymer melt with the flakes, for example into an extruder or an injection molding machine.

The fabrics producing the cutting scrap which is cut into flakes may comprise fibers of any desired known material. Customary materials used for fibers are, for example, glass fibers, carbon fibers, aramid fibers, mineral fibers or polymeric fibers. The method of the present invention is particularly suitable for cutting scrap from fabrics fabricated from carbon fibers, for which it is not sensible to use the existing methods of recycling.

Polymers comprising carbon fibers as enforcement and carbon fiber fabric cutting scrap are currently being sent for thermal recovery. Yet this represents a colossal waste of high-value material in that it is incinerated in thermal recovery and cannot be employed for its original purpose. The method of the present invention provides for carbon fibers in particular a way to use cutting scrap for the production of reinforced polymers.

Cutting the cutting scrap into flakes can be effected for example with blades, for example diecutting blades or roller blades, a diecutting lattice or a laser. It is similarly possible to use a CNC cutter for cutting the cutting scrap into flakes. It is particularly preferable to use diecutting lattices or lasers. Flakes are generally cut using the same means as also used to convert the fabrics into the form for production of continuous strand reinforced moldings. All that is necessary for this is to adapt the form of the, for example, diecutting lattices or of the blades such that they can be used to cut flakes.

Cutting the cutting scrap into flakes can be effected concurrently with the cutting to size of the fabric for the fiber reinforced component to be produced. It is alternatively also possible, as will be appreciated, to comminute the cutting scrap into flakes in a separate second step. Concurrent fabric cutting and scrap cutting is effected using tools permitting such cutting. Appropriately engineered diecutting blades or diecutting lattices then have to be used for this purpose. However, the preference in this case is to use a CNC cutter.

When the cutting scrap is comminuted into flakes in a separate step, any desired suitable cutting-to-size tool can be used, in which case the aforementioned cutting-to-size tools are particularly suitable. When the cutting scrap is cut into flakes in a separate step, the cutting scrap can be cut into flakes in individual plies or alternatively with two or more plies of cutting scrap in superposed layers. The maximum number of layers which can be cut at the same time depends on the tool used. For reasons of efficiency, it is preferable to cut as many plies as possible at one time provided this does not lead to an increase in the overall cutting time, for example because of slower forward feed speeds needed, as with laser cutting.

The edge length of flakes to which the fabric cutting scrap is cut is preferably in the range from 10 to 50 mm, especially in the range from 10 to 20 mm. Edge length here is also dependent on the machine used to admix the flakes to the polymer melt.

As the flakes are mixed into the polymer melt, the individual flakes disintegrate into individual fibers, which then become mixed into the polymer melt. Depending on the size of the flakes used and the shearing effect in the apparatus for intermixing the flakes, some of the fibers will break, so the properties of the fiber reinforced polymer thus obtained correspond to the properties of a chopped strand reinforced polymer.

Fiber breakage is due in particular to the brittleness of carbon fibers and the processing in a screw plunger machine, where the rotation of the screws is responsible for shearing the material.

Suitable apparatus for admixing and kneading the flakes into the polymer melt are in particular screw plunger machines, for example injection molding machines or extruders, in particular extruders. The flakes are added therein at a position customary for the admixture of fibers. The position for admixing fibers is typically situated downstream of the feed zone in a region where the polymer added to the screw plunger machine has completely melted. When the screw plunger machine is already being fed a polymer melt, the feed port for the flakes can be situated directly following the feed port for the polymer melt. Since a screw plunger machine is typically fed with polymer pellets, i.e., a plastic in solid form, it is necessary to first melt the polymer before the flakes are added. Adding the flakes into the polymer melt provides more homogeneous commixing of the melt with the flakes and hence a more uniform distribution of the resultant individual fibers in the polymer melt.

When the screw plunger machine used is an extruder, not only single screw extruders but also multiple screw extruders, for example twin screw extruders, can be used. It is particularly preferable to use twin screw extruders, since they have a better mixing effect in particular compared with single screw extruders. A twin screw extruder further permits easier addition of fillers and can be operated with a variable fill content, also resulting in good devolatilization and making it possible to achieve better control of product properties. In addition, a twin screw extruder has very good self-cleaning properties, unlike a single screw extruder.

The flakes are introduced into the screw plunger machine, for example the extruder, via a feed port that preferably comprises a feed screw. A feed screw provides a uniform rate of addition of the flakes into the polymer melt. An addition of flakes without a feed screw, for example via a feed aperture, carries the risk that the flakes will not be absorbed by the polymer melt or that flakes will only occasionally co-arrive into the polymer melt, so the proportion of fibers in the polymer would be too low.

The feed screw provides control over the amount of flakes which is added to the polymer melt. In particular, a feed screw can be used to achieve a forced feed of the flakes, allowing an up to 50 wt % proportion of flakes and hence of fibers in the polymer melt. The proportion of flakes and hence of fibers following the metered addition into the polymer melt is preferably in the range from 1 to 50 wt %, especially in the range from 1 to 40 wt %.

The length of the fibers in the intermediate article results, firstly, from the shearing of the fibers in the screw plunger machine and, secondly, from the dimensioning of the pellet material cut out of the polymer melt. Maximum fiber length corresponds to the maximum longitudinal extent of an individual pellet. If longer fibers are desired, it is not only necessary to cut flakes having a larger edge length but also to produce a larger pellet. The pellet is preferably cylindrical and its largest extent is typically the height of the cylinder. Alternatively, however, it is also possible to choose a larger diameter and a lower height. But since the fibers are caused by the feed of the polymer melt to become aligned in a substantially parallel arrangement in the axial direction relative to the axis of the holes in the pelletizing die, it is typically the axial extent of the pellet which determines the maximum fiber length.

The polymer which is admixed with the flakes can be a thermoplastic polymer, a thermosetting polymer or an elastomeric polymer. It is particularly preferable for the polymer melt to comprise a thermoplastic polymer, and it is most preferable for the polymer melt to be a melt of a thermoplastic polymer.

The thermoplastic polymer is preferably selected from polybutylene terephthalate (PBT), polyethylene terephthalate (PET), polyoxymethylene (POM), polyamide (PA), polypropylene (PP), polyethylene (PE), polyether sulfone (PES) or a mixture of two or more thereof. In addition to the aforementioned thermoplastic polymers, any other desired thermoplastic polymer can also be used.

The intermediate article obtained by the method of the present invention is more preferably a pellet material. In addition to a pellet material, however, the intermediate article can also take the form of sheets or extrudates. When the intermediate article is a pellet material comprising fiber, this pellet material is produced in the usual manner of pellets by the polymer melt being forced through a pelletizing die and chopped into pellets by a pelletizing knife. One possible way to do this is first to produce a polymer extrudate which is cooled down then chopped into pellets. Alternatively, and conventionally, the polymer forced through the pelletizing die is directly face cut. This cutting can take place in air, in which case the cut pellets preferably fall into a cooling liquid and solidify. Water is an example of a suitable cooling liquid. Alternatively, underwater pelletization is also possible, in which case the polymer melt is forced through the pelletizing die into a cooling liquid and directly face cut into pellets. In either case, the pellets are exported with the cooling liquid, then freed of the cooling liquid and dried.

The pellet material thus obtained can be further processed in any desired manner whereby plastic pellets can be processed into a final article. For instance, the plastic pellets can be molded into a final article by extrusion or injection molding. Any desired injection molding machine or extrusion machine can be used here provided it is useful for producing final articles and more particularly is suitable for the processing of fiber reinforced plastics.

Moldings obtainable from the pellet material obtained by the method of the present invention include all specifically geometrically demanding shapes that are also obtainable with commercially available fiber reinforced thermoplastics, for example cylinder head gaskets, intake manifolds for turbochargers, switch housings.

### EXAMPLE

To produce a fiber reinforced nylon, a commercially available twin screw extruder was retrofitted with a metering unit for carbon fiber flakes. To this end, a stock reservoir vessel having a bottom-spindle fitted in its base was mounted centrally above the side feed of the twin screw extruder.

To produce a nylon-6,6 reinforced with 20 wt % of carbon fibers, the first step was to cut a laid fabric continuous strand carbon fiber mat scrap with a CNC cutter into 20×20 mm flakes. The flakes thus cut were then introduced into the stock reservoir vessel above the size feed of the twin screw extruder and gravimetrically metered into the melt of the nylon-6,6 via the side feed. The material thus obtained was pelletized directly after the extruder.

The material thus obtained was used to produce test specimens on an injection molding machine in a further step of processing. The values measured on the test specimens and also the values measured on test specimens of a commercially available nylon reinforced with 20 wt % of chopped carbon fiber (Ultramid® A3WC4 from BASF SE) are shown in table 1. “Example” refers to the values of the test specimens formed from the nylon obtained according to the present invention and “comparator” refers to the values of the test specimens formed from the commercially available nylon.

Comparison of the values reveals that the properties correspond substantially to those of a customary polymer reinforced with chopped carbon fiber.

TABLE 1
Characteristic values of a fiber reinforced nylon-6,6 obtained
by the method of the present invention and of a commercially
available fiber reinforced nylon-6,6 as originally filed

| Properties | Test method | Example | Comparator |
|---|---|---|---|
| density [kg/m³] | EN ISO | 1230 | 1220 |
| | 1183-2:2004-10 | | |
| modulus of elasticity | DIN EN ISO | 14600 | 16800 |
| [MPa] | 527-1/-2:2012-06 | | |
| breaking stress [MPa] | DIN EN ISO | 200 | 235 |
| | 527-1/-2:2012-06 | | |
| breaking extension [%] | DIN EN ISO | 2.8 | 2.4 |
| | 527-1/-2:2012-06 | | |
| impact strength | DIN EN ISO | 54 | 57 |
| at 23° C. [kJ/m²] | 179-1:2010-11 | | |
| notched impact strength | DIN EN ISO | 4.7 | 6 |
| at 23° C. [kJ/m²] | 179-1:2010-11 | | |

1. A method of using fabric cutting scrap, which method comprises the steps of:
(a) cutting the cutting scrap into flakes,
(b) admixing the flakes to a polymer melt,
(c) kneading the polymer melt with the flakes, so the flakes disintegrate into individual fibers, and
(d) molding the polymer melt with the admixed fibers into an intermediate article,
wherein the fabric is fabricated from carbon fiber.

2. The method according to claim 1, wherein the fabric is a fabric woven, laid or knitted from continuous strand fiber.

3. (canceled)

4. The method according to claim 1, wherein the flakes are treated with a sizing composition before they are admixed to the polymer melt.

5. The method according to claim 1, wherein the cutting scrap is cut into flakes using a blade, a diecutting lattice or a laser.

6. The method according to claim 1, wherein a screw plunger machine is used to admix the flakes and knead the polymer melt with the flakes.

7. The method according to claim 6, wherein the screw plunger machine is an extruder.

8. The method according to claim 7, wherein the extruder comprises a feed port with a feed screw to admix the flakes to the polymer melt.

9. The method according to any claim 1 wherein the polymer melt comprises a thermoplastic polymer.

10. The method according to claim 9, wherein the thermoplastic polymer is selected from polybutylene terephthalate, polyethylene terephthalate, polyoxymethylene, polyamide, polypropylene, polyethylene, polyether sulfone or mixtures of two or more thereof.

11. The method according to claim 1, wherein the intermediate article is a pellet material comprising fiber.

12. The method according to claim 2, wherein the flakes are treated with a sizing composition before they are admixed to the polymer melt.
